(19) United States
(12) Patent Application Publication
(10) Pub. No.: US 2010/0255380 A1
(43) Pub. Date: Oct. 7, 2010

(54) SEPARATOR FOR NONAQUEOUS ELECTROLYTE BATTERY AND NONAQUEOUS ELECTROLYTE BATTERY

(75) Inventors: Yasunori Baba, Plano, TX (US); Naoki Imachi, Hyogo (JP); Atsushi Nakajima, Aichi (JP); Michihiko Irie, Shiga (JP); Masanori Nakamura, Shiga (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: SANYO ELECTRIC CO., LTD., Moriguchi-city, Osaka (JP); TOYO BOSEKI KABUSHIKI KAISHA, Osaka-city, Osaka (JP)

(21) Appl. No.: 12/680,424

(22) PCT Filed: Sep. 22, 2008
(86) PCT No.: PCT/JP2008/067113

§ 371 Date: Mar. 26, 2010

(30) Foreign Application Priority Data
Sep. 27, 2007 (JP) 2007-251967

(51) Int. Cl. H01M 2/16

(52) U.S. Cl. 429/246; 429/247

(57) ABSTRACT

To obtain a nonaqueous electrolyte battery that has an excellent nonaqueous electrolyte permeability into an electrode and an excellent electrolyte retentivity of the electrode and achieves a large capacity, a high energy density and a good high-temperature charge characteristic. A separator used for a nonaqueous electrolyte battery is formed by disposing a porous layer made of inorganic fine particles and a resin binder on a porous separator substrate. The resin binder is made of at least one resin selected from the group consisting of polyimide resins and polyamideimide resins, the resin having an acid value of 5.6 to 28.0 KOHmg/g and a logarithmic viscosity of 0.5 to 1.5 dl/g. The content of the resin binder in the porous layer is 5% by weight or more.

### TECHNICAL FIELD

This invention relates to separators used for nonaqueous electrolyte batteries, such as lithium ion secondary batteries and polymer secondary batteries, and relates to nonaqueous electrolyte batteries using the separators.

### BACKGROUND ART

In recent years, size and weight reduction of mobile information terminals, such as cellular phones, notebook computers and PDAs, has rapidly progressed. Batteries serving as their driving power sources are being required to achieve a much higher capacity. Among various types of secondary batteries, lithium ion batteries having particularly high energy densities have increased the capacity over the years, but under the existing conditions cannot fully respond to the above requirement. In addition, recently, the application of lithium ion batteries has been expanded beyond mobile information terminals, such as cellular phones, to serve as middle to large size batteries for electric tools, electric cars or hybrid cars by taking advantage of their features. Thus, there has been a tremendous increase in the demand for further increasing the capacity and power of lithium ion batteries.

There has recently been disclosed a technique of increasing the capacity and power of a battery by increasing the end-of-charge voltage from 4.1-4.2 V (4.2-4.3 V as a voltage versus the potential of a lithium reference electrode (vs. Li/Li⁺)) that would conventionally be used to 4.3 V or more (4.4 V (vs. Li/Li⁺) or more) to increase the utilization factor of the positive electrode (see Patent Document 1).

For the purpose of increasing the battery capacity, consideration has been made of high-density packing of electrode material, thickness reduction of a current collector, a separator or a battery housing that are members uninvolved in power generation factors, and other measures. On the other hand, for the purpose of increasing the battery power, consideration has been made of increasing the electrode area, and other measures. In terms of battery construction, challenges of electrolyte permeability into each electrode and electrolyte retentivity of the electrode are being given more attention today than in the early days of development of lithium ion batteries. It has become necessary, in establishing a novel battery construction, to solve the problems as thus far described in order to ensure the battery performance and reliability.

A technique is disclosed in which, in order to solve the above problems, a porous layer having an excellent nonaqueous electrolyte permeability is disposed between at least one of the positive and negative electrodes and a separator and allowed to function as a diffusion path for supplying an electrolytic solution present in a remaining space of the battery to the interior of the electrode, thereby improving the battery characteristics (see Patent Documents 2 and 3). When the positive electrode is charged to above 4.40 V versus the potential of a lithium reference electrode, the electrolytic solution may be likely to be oxidatively decomposed to largely reduce the amount of electrolytic solution in the battery. The above technique acts more effectively under such a condition and, therefore, is a useful technique for increasing the capacity and power of a battery.

The inventors have considered, as a porous layer to be disposed between at least one of positive and negative electrodes and a separator, a porous layer made of inorganic fine particles and a resin binder, and have considered, as the resin binder, polyimide, polyamideimide or like resin.

Techniques using polyamide, polyimide, polyamideimide or like resin for a separator have already been considered for the purpose of increasing the heat resistance (see Patent Documents 4 to 7). In these conventional techniques, however, the resins have been considered simply focusing on improving the safety.

### Patent Document 1: Published Japanese Patent Application No. 2006-147191

### Patent Document 2: Published Japanese Patent Application No. 2007-123237

### Patent Document 3: Published Japanese Patent Application No. 2007-123238

Patent Document 4: Published Japanese Patent Application No. H10-6453
Patent Document 5: Published Japanese Patent Application No. H10-324758

### Patent Document 6: Published Japanese Patent Application No. 2000-100408

### Patent Document 7: Published Japanese Patent Application No. 2001-266949

### DISCLOSURE OF THE INVENTION

If an organic solvent is used in order to dissolve polyimide, polyamideimide or like resin, the organic solvent may cause a problem in that it will dissolve poly(vinylidene fluoride) (PVdF) used as a binder for a positive electrode. Therefore, in disposing a porous layer between an electrode and a separator, the porous layer cannot be placed on the surface of a positive electrode and must be placed on the surface of the separator facing the positive electrode. If the porous layer is placed on the positive electrode side of the separator in this manner, this may cause a problem in that when the battery voltage is above 4.30 V (above 4.40 V (vs. Li/Li⁺)), the high-temperature charge characteristic of the battery may be largely deteriorated. It can be assumed that the reason for this is that when the potential of the positive electrode is above 4.40 V (vs. Li/Li⁺), the resin such as polyimide or polyamideimide in the porous layer adjacent to the positive electrode surface is oxidatively decomposed and a reaction product derived from the oxidative decomposition has an adverse effect on intercalation reaction of lithium in the interior of the battery.

An object of the present invention is to provide a separator for a nonaqueous electrolyte battery that has an excellent nonaqueous electrolyte permeability into an electrode and an excellent electrolyte retentivity of the electrode and achieves a large capacity, a high energy density and a good high-temperature charge characteristic, and provide a nonaqueous electrolyte battery using the separator.

The present invention is directed to a separator used for a nonaqueous electrolyte battery, wherein the separator is formed by disposing a porous layer made of inorganic fine particles and a resin binder on a porous separator substrate, the resin binder is made of at least one resin selected from the group consisting of polyimide resins and polyamideimide resins, the resin having an acid value of 5.6 to 28.0 KOHmg/g and a logarithmic viscosity of 0.5 to 1.5 dl/g, and the content of the resin binder in the porous layer is 5% by weight or more.

The resin materials, such as polyimide and polyamideimide, are required to be dissolved in an organic solvent in forming a film therefrom. Generally known as a method for improving the solubility of a polyimide resin is a method of introducing alkyl bonds or ether bonds into the polyimide resin. However, these bonds are poor in resistance to electrophilic reaction, and polyimide resins tend to be oxidatively decomposed when used in the vicinity of the positive electrode. Polyamideimide resins superior in solubility to polyimide tend to be likewise oxidized by abstraction of hydrogen atoms from amide bonds when the battery voltage is above 4.30 V (above 4.40 V (vs. Li/Li⁺)). Therefore, in order to improve the high-temperature charge characteristic when the battery voltage is above 4.30 V (above 4.40 V (vs. Li/Li⁺)), the molecular structure of the polyimide resin or polyamideimide resin used must be made stable to oxidation reaction.

In the present invention, what is used as the resin binder in the porous layer is at least one resin which is selected from the group consisting of polyimide resins and polyamideimide resins and the acid value of which is 5.6 to 28.0 KOHmg/g. Since the acid value of the resin is 5.6 to 28.0 KOHmg/g and the resin contains acid groups, the electron density of the main chain of the resin can sufficiently be reduced to reduce the oxidation of the resin and thereby increase the high-temperature charge characteristic.

In the present invention, the acid groups giving the resin the acid value are preferably carboxyl groups. Therefore, the acid value to be given by carboxyl groups is preferably within the range of 5.6 to 28.0 KOHmg/g.

In addition, the acid value of the resin has an effect on the affinity to nonaqueous electrolyte. If the acid value is below 5.6 KOHmg/g, this does not provide improved high-temperature charge characteristic and provides insufficient affinity to nonaqueous electrolyte to reduce the nonaqueous electrolyte permeability of the resin. Therefore, sufficient battery properties cannot be achieved. On the other hand, if the acid value of the resin is above 28.0 KOHmg/g, the resin binder becomes more likely to swell and dissolve in nonaqueous electrolyte. Therefore, when the separator is immersed into nonaqueous electrolyte, inorganic fine particles may fall off. The acid value of the resin is more preferably within the range of 5.6 to 22.5 KOHmg/g, and most preferably within the range of 5.6 to 16.8 KOHmg/g.

The logarithmic viscosity of the resin binder in the present invention is within the range of 0.5 to 1.5 dl/g. If the logarithmic viscosity is lower than 0.5 dl/g, the resin binder may dissolve or swell in nonaqueous electrolyte to cause falling off of inorganic fine particles, which is undesirable. On the other hand, if the logarithmic viscosity is higher than 1.5 dl/g, more functional groups will be consumed with increasing molecular weight. This makes it difficult for the resin binder to meet the acid value range of 5.6 to 28.0 KOHmg/g. Note that the logarithmic viscosity is a value that can be obtained by measuring a solution of 0.6 g of resin dissolved in 100 ml of N-2-methyl-pyrrolidone (NMP) with an Ubbelohde viscosimeter under a condition of 25° C.

In the present invention, the proportion of imide bonds to the total amount of imide bonds and amide bonds in the resin binder is preferably 40% to 100%. If the proportion of imide bonds is lower than 40%, the resin binder is likely to cause an oxidative decomposition reaction due to hydrogen abstraction from amide bonds. This may deteriorate the high-temperature charge characteristic when the battery voltage is above 4.30 V. The proportion of imide bonds is more preferably within the range of 45% to 100%, and most preferably within the range of 50% to 100%. Note that if the proportion of imide bonds is 100%, the resin is a polyimide resin.

In the present invention, the molecular weight distribution (Mw/Mn) of the resin binder is preferably within the range of 2 to 4. The value of the molecular weight distribution increases with the progress of polymerization reaction. If the above logarithmic viscosity range is met, a resin having a molecular weight distribution of 2 to 4 is obtained in the inventors' experience. However, since in the present invention carboxyl groups are introduced into the main chain of the resin, an abnormality in the polymerization temperature or the catalyst amount may cause the resin to produce a chain branching reaction or a crosslinking reaction beginning at the carboxyl groups serving as reaction sites, thereby giving a molecular weight distribution of above 4. Branched and crosslinked resins tend to be inferior in mechanical properties (strength and elongation) to chain polymers having equal molecular weights. Therefore, the molecular weight distribution is preferably 2 to 4, more preferably 2 to 3.5, and most preferably 2 to 3.

If the molecular weight distribution is above 4, deterioration in mechanical properties due to chain branching reaction is likely to cause falling off of inorganic particles or delamination of the porous layer in the battery production process.

On the other hand, if the molecular weight distribution is below 2, polymerization is not sufficiently promoted and the resin binder is likely to fail to meet a logarithmic viscosity of above 0.5 dl/g.

Furthermore, in the present invention, the static contact angle of the resin binder with water is preferably not more than 90°. The static contact angle of the resin binder with water has an effect on the affinity to nonaqueous electrolyte, like the acid value. If the static contact angle with water is greater than 90°, this provides poor affinity to nonaqueous electrolyte to reduce the nonaqueous electrolyte permeability of the resin binder. Therefore, sufficient battery properties may not be achieved. The static contact angle with water is more preferably not more than 85°, and most preferably not more than 80°. The lower limit of the static contact angle with water is generally 75° or more.

The inorganic fine particles to be used in the porous layer in the present invention are not particularly limited so long as they are fine particles made of an inorganic material. For example, inorganic materials that can be used are titania (titanium oxide), alumina (aluminum oxide), zirconia (zirconium oxide), and magnesia (magnesium oxide). A titania to be particularly preferably used is one having a rutile structure.

Considering the dispersibility in slurry, inorganic fine particles whose surfaces are treated with an oxide of Al, Si, Ti or the like can be preferably used. Considering the stability in the interior of the battery (reactivity with lithium) and cost, fine particles of alumina or rutile-structure titania can be preferably used as inorganic fine particles to be used in the present invention.

The average particle size of the inorganic fine particles in the present invention is preferably 1 μm or less. It can be assumed that if the average particle size of the inorganic fine particles is larger than the average pore size of the porous separator substrate, the inorganic fine particles hardly enter the interior of the separator substrate. On the other hand, if the average particle size of the inorganic fine particles is smaller than the average pore size of the porous separator substrate, the inorganic fine particles may enter the interior of the separator. If the inorganic fine particles enter the interior of the separator substrate, pores in the interior of the separator may be partly passed through when the separator undergoes winding tension in producing a battery or is processed into a flattened shape after the winding, whereby small-resistance sites may be formed in the separator to cause a battery defect. Therefore, the average particle size of the inorganic fine particles is preferably larger than the average pore size of the porous separator substrate. Specifically, the average particle size of the inorganic fine particles is generally preferably within the range of 0.2 to 1.0 μm.

The polyimide resins and polyamideimide resins in the present invention are resins that can be obtained by reacting an acid component with a base component.

Examples of the acid component include not only trimellitic acid, its anhydride and its acid chloride but also tetracarboxylic acids and their anhydrides including pyromellitic acid, biphenyltetracarboxylic acid, biphenylsulfonetetracarboxylic acid, benzophenonetetracarboxylic acid, biphenylethertetracarboxylic acid, ethylene glycol bis(anhydrotrimellitate), propylene glycol bis(anhydrotrimellitate) and propylene glycol bis(anhydrotrimellitate), and aromatic dicarboxylic acids including terephthalic acid, isophthalic acid, diphenylsulfonedicarboxylic acid, diphenyletherdicarboxylic acid and naphthalenedicarboxylic acid.

An example of the method of introducing acid groups, such as carboxyl groups, into the resin molecular chain is a method using an acid component containing acid groups, such as carboxyl groups, in the molecular chain. Examples of the acid component allowing introduction of carboxyl groups include trimellitic acid, trimellitic anhydride and trimesic acid.

Particularly, trimellitic acid and trimellitic anhydride can be preferably used, because they can increase the thermal resistance of the resin and increase the stability to charge-discharge reaction.

The content of trimellitic acid or trimellitic anhydride is preferably within the range of 30% to 100% by mole of the total amount of all of acid components, more preferably within the range of 50% to 100% by mole, and still more preferably within the range of 70% to 100% by mole.

Examples of the base component include aromatic diamines, such as m-phenylenediamine, p-phenylenediamine, 4,4′-diaminodiphenylmethane, 4,4′-diaminodiphenylether, 4,4′-diaminodiphenylsulfone, benzine, o-tolidine, 2,4-tolylenediamine, 2,6-tolylenediamine, xylylenediamine and naphthalenediamine, and their diisocyanates.

Among the base components described above, 4,4′-diaminodiphenylmethane, o-tolidine and their diisocyanates can be particularly preferably used. In using these base components, their content is preferably within the range of 30% to 100% by mole of the total amount of all of base components, more preferably within the range of 50% to 100% by mole, and still more preferably within the range of 70% to 100% by mole.

An example of the method of introducing carboxyl groups into the molecular chain of the resin binder is a method using trimellitic acid or trimellitic anhydride, as described above. Trimellitic anhydride may be used by adjusting its degree of ring opening by hydrolysis or other methods. Alternatively, carboxyl groups may be introduced into the molecular chain by a method using an amic acid forming reaction of carboxylic anhydride and an amine.

The resin binder in the present invention is preferably selected in consideration of (1) whether it ensures the dispersibility of inorganic fine particles (whether it can prevent reaggregation of inorganic fine particles), (2) whether it has an adhesion capable of withstanding a battery production process, (3) whether it can fill in clearances between inorganic fine particles created by swelling after absorption of the electrolytic solution, and (4) whether it can be less eluted into the electrolytic solution.

The content of the resin binder in the porous layer in the present invention is preferably 5% by weight or more, and more preferably within the range of 5% to 15% by weight. If the resin binder content is too small, this may cause a reduction in the strength of adhesion to inorganic fine particles and a reduction in the dispersibility of inorganic fine particles in a slurry for forming the porous layer. On the other hand, if the resin binder content is too large, this may reduce the air permeability in the porous layer, reduce the air permeability as a separator and in turn reduce the load characteristic of the battery.

The porous layer in the present invention can be formed by applying a slurry containing inorganic fine particles and a resin binder on a porous separator substrate and then drying the slurry.

The solvent to be used for the slurry containing inorganic fine particles and a resin binder is not particularly limited, and may be any solvent that can dissolve the resin binder. Examples of the solvent include N,N-dimethylacetamide (DMAc), N-methyl-2-pyrrolidone (NMP), hexamethyltriamide phosphate (HMPA), N,N-dimethylformamide (DMF), dimethylsulfoxide (DMSO) and γ-butylolactone (γ-BL).

The thickness of the porous layer in the present invention is not particularly limited, but is preferably within the range of 0.5 to 4 μm and more preferably within the range of 0.5 to 2 μm. The porous layer may be provided only on one surface of the porous separator substrate or may be provided on both surfaces thereof. If the porous layer is provided on both surfaces of the substrate, the above preferable thickness range is the thickness range for each surface of the substrate. If the thickness of the porous layer is too small, this may reduce the nonaqueous electrolyte permeability into the electrode and the electrolyte retentivity of the electrode. On the other hand, if the thickness of the porous layer is too large, this may reduce the load characteristic and energy density of the battery.

The air permeability of the separator obtained by disposing a porous layer on a porous separator substrate is preferably not more than twice that of the porous separator substrate, more preferably not more than 1.5 times that of the porous separator substrate, and still more preferably not more than 1.25 times that of the porous separator substrate. If the air permeability of the separator is much higher than that of the porous separator substrate, this may make the load characteristic of the battery too large.

Materials that can be used as the porous separator substrate in the present invention are porous films made of polyolefin, such as polyethylene or polypropylene. For example, separators as conventionally used for nonaqueous electrolyte secondary batteries can be used. For example, the thickness of the porous separator substrate is preferably within the range of 5 to 30 μm, the porosity thereof is preferably within the range of 30% to 60%, and the air permeability thereof is preferably within the range of 50 to 400 seconds per 100 ml.

The porous layer in the present invention is, as described previously, a porous layer in which a resin binder is less likely to be oxidatively decomposed even if the potential of the positive electrode is above 4.40 V (vs. Li/Li⁺). Therefore, if the porous layer is disposed on the positive electrode side of the porous separator substrate, the above effects of the invention are particularly pronounced.

Furthermore, in nonaqueous electrolyte secondary batteries whose positive electrodes have an end-of-charge voltage of above 4.40 V (vs. Li/Li⁺), the above effects of the invention are more pronounced. Therefore, the nonaqueous electrolyte secondary battery according to this aspect of the invention is preferably a nonaqueous electrolyte secondary battery whose positive electrode is capable of being charged to above 4.40 V (vs. Li/Li⁺).

The nonaqueous electrolyte battery according to the present invention may be a primary battery but is preferably a nonaqueous electrolyte secondary battery.

The positive electrode in the present invention is not particularly limited so long as it is a positive electrode used in a nonaqueous electrolyte battery. Examples of an active material for the positive electrode include lithium cobaltate, lithium-nickel composite oxides, such as lithium nickelate, lithium-transition metal composite oxides as represented by LiNiₓCO_{y}Mn_{z}O₂ (x+y+z=1), and olivine phosphate compounds.

The negative electrode that can be used in the present invention is not limited so long as it can be used as a negative electrode for a nonaqueous electrolyte battery. Examples of an active material for the negative electrode include carbon materials, such as graphite and coke, tin oxide, metal lithium, and metals capable of forming an alloy with lithium, such as silicon.

The nonaqueous electrolyte in the present invention is not particularly limited so long as it can be used for nonaqueous electrolyte batteries. Examples of a lithium salt in the electrolyte include LiBF₄, LiPF₆, LiN(SO₂CF₃)₂, LiN(SO₂C₂F₅)₂, and LiPF₆₋ₓ(CₙF₂ₙ₊1)ₓ where 1<x<6 and n=1 or 2. One of these materials or a mixture of two or more of them can be used as the lithium salt. The concentration of the lithium salt is not particularly limited but is preferably approximately 0.8 to approximately 1.5 mol/L.

Preferred solvents to be used for the nonaqueous electrolyte are carbonate solvents, such as ethylene carbonate (EC), propylene carbonate (PC), γ-butylolactone (γ-BL), diethyl carbonate (DEC), ethyl methyl carbonate (EMC) and dimethyl carbonate (DMC). More preferred solvents to be used are mixed solvents made of a cyclic carbonate and a chain carbonate.

The nonaqueous electrolyte in the present invention may be an electrolytic solution or a gel polymer. Examples of the polymer material include solid electrolytes including polyether solid polymers, polycarbonate solid polymers, polyacrylonitrile solid polymers, oxetane polymers, epoxy polymers, copolymers made of two or more of them, and their crosslinked polymers.

### EFFECTS OF THE INVENTION

In the present invention, what is used as the resin binder is at least one resin which is selected from the group consisting of polyimide resins and polyamideimide resins, the acid value of which is 5.6 to 28.0 KOHmg/g and the logarithmic viscosity of which is 0.5 to 1.5 dl/g. Therefore, the electron density of the resin main chain can be reduced and the electron abstraction reaction due to oxidation can be reduced, whereby a nonaqueous electrolyte battery having a good high-temperature charge characteristic can be obtained.

Furthermore, since the resin binder in the present invention has the acid value and logarithmic viscosity described above, it does not dissolve in nonaqueous electrolyte and has an appropriate affinity to nonaqueous electrolyte. Therefore, the resin binder is excellent in nonaqueous electrolyte permeability.

The separator according to the present invention is formed by disposing a porous layer made of inorganic fine particles and a resin binder on a porous separator substrate, and the resin binder used is a resin binder excellent in affinity to nonaqueous electrolyte as described above. Therefore, a nonaqueous electrolyte battery can be provided that has an excellent nonaqueous electrolyte permeability into an electrode and an excellent electrolyte retentivity of the electrode and achieves a large capacity and a high energy density.

### BRIEF DESCRIPTION OF DRAWINGS

FIG. 1 is a schematic cross-sectional view showing a separator according to the present invention.

FIG. 2 is a graph showing the relation between charge voltage and discharge capacity retention in Examples and Comparative Examples.

### LIST OF REFERENCE NUMERALS

1 porous separator substrate
2 porous layer
3 separator

### BEST MODE FOR CARRYING OUT THE INVENTION

Hereinafter, the present invention will be described in more detail with reference to the following Examples. However, the present invention is not at all limited by the following Examples, and can be embodied in various other forms appropriately modified without changing the spirit of the invention.

### Evaluation in Formation of Porous Layer>

### Example A1

### Production of Separator

### Synthesis of Carboxyl Group-Containing Resin

In a four-necked flask provided with a condenser and a nitrogen gas inlet, 0.99 mol of trimellitic anhydride, 0.01 mol of trimesic acid and 1.0 mol of 4,4′-diaminodiphenylmethane diisocyanate were mixed with N-methyl-2-pyrrolidone (NMP) to give a solid content concentration of 20% by weight, and 0.01 mol of diazabicycloundecene was added as a catalyst to the mixture. The mixture was stirred in the flask and allowed to react at 120° C. for four hours.

The solvent-soluble polyamideimide resin thus obtained had a solid content concentration of 20% by weight and a logarithmic viscosity of 0.6 dl/g. The acid value of the resin was 11.2 KOHmg/g. The proportion of imide bonds to the total amount of imide bonds and amide bonds in the resin was 48%. The molecular weight distribution (Mw/Mn) of the resin was 2.7. The static contact angle of the resin with water was 85°.

Preparation of Application Liquid

Next mixed were 10 parts by weight of the obtained solvent-soluble polyamideimide resin solution (solid content: 20% by weight), 12 parts by weight of polyethylene glycol (trade name “PEG-400”, manufactured by Sanyo Chemical Industries, Ltd.), 40 parts by weight of NMP and 38 parts by weight of titanium oxide (trade name “KR-380”, manufactured by Titan Kogyo, Ltd., average particle size: 0.38 μm). The mixture was put into a container made of polypropylene, together with zirconium oxide beads (trade name “Torayceram Beads”, manufactured by Toray Industries, Inc., diameter: 0.5 mm), followed by allowing the inorganic fine particles to be dispersed with a paint shaker (manufactured by Toyo Seiki Seisaku-sho, Ltd.) for six hours.

The obtained dispersion was filtered through a filter having a filtration limit of 5 μm, thereby obtaining an application liquid A1.

Film Formation (Production of Separator)

A piece of porous polyethylene film (thickness: 16 μm, porosity: 51%, average pore size: 0.15 μm, air permeability: 80 seconds per 100 ml) was put as a porous separator substrate on a corona-treated surface of a sheet of propylene film (trade name “PYLEN-OT”, manufactured by Toyobo Co., Ltd.). The above application liquid A1 was applied on the piece of porous polyethylene film with the clearance set at 10 μm. After the application, the polyethylene film piece was passed through an atmosphere at a temperature of 25° C. and a relative humidity of 40% in 20 seconds, then immersed in a water bath, then picked up from the water path, then dried at 70° C. by hot air, thereby producing a separator.

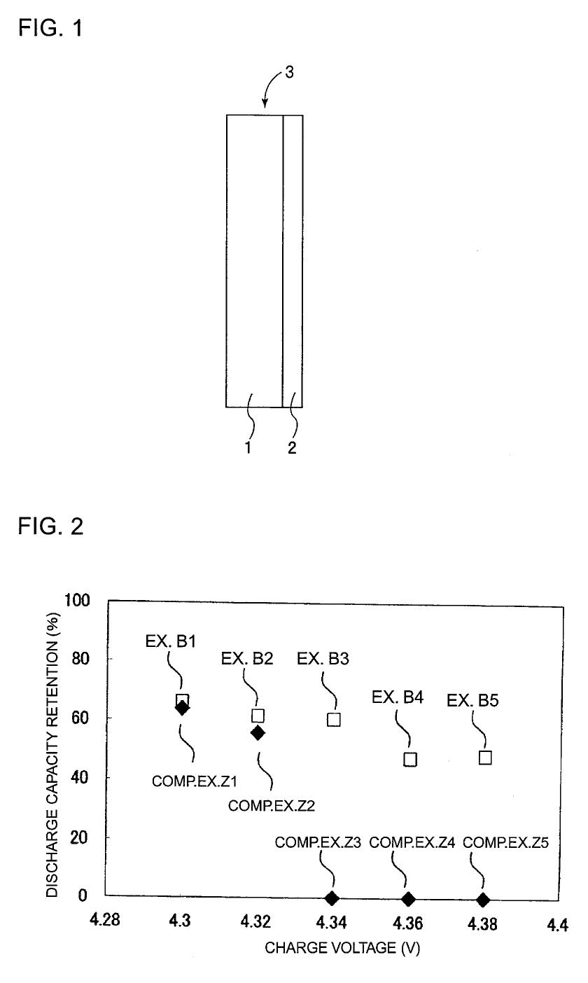

FIG. 1 is a schematic cross-sectional view showing the obtained separator. As shown in FIG. 1, the separator 3 includes a porous layer 2 formed by applying the application liquid A1 on the porous separator substrate 1.

The thickness of the obtained separator was 18 μm. Therefore, the thickness of the porous layer was 2 μm. The air permeability of the obtained separator was 100 seconds per 100 ml, which is 1.25 times that of the porous separator substrate. The ratio of polyimide resin to titanium oxide in the porous layer is 5 parts by weight of polyamideimide resin to 95 parts by weight of titanium oxide.

The logarithmic viscosity, solid content concentration, imide bond proportion, acid value, static contact angle and molecular weight distribution of the polyamideimide resin solution, and the air permeability and thickness of the separator were measured in the following manners.

(Logarithmic Viscosity [dl/g])

A solution of 0.5 g of the polymer dissolved in 100 ml of NMP was measured in terms of viscosity at 25° C. with an Ubbelohde viscosimeter.

(Solid Content Concentration [%])

Approximately 1.0 g of the resin solution was dripped on a piece of aluminum foil and dried in vacuum at 250° C. for 12 hours. The solid obtained after the drying was measured in terms of weight. The solid content concentration was obtained according to the following equation:

Solid Content Concentration[%]=(Weight of Solid After

Drying[g])/(Weight of Resin Solution Before Drying[g])×100

(Imide Bond Proportion[%])

The resin solution was measured at 40 degrees by ¹H-NMR using DMSO containing heavy hydrogen (deuterated DMSO) to identify imide bonds and amide bonds. Based on this, the proportion of imide bonds to the total amount of imide bonds and amide bonds was calculated, thereby obtaining an imide bond proportion.

(Acid Value [KOHmg/g])

To a solution of 0.4 g of the polymer dissolved in 20 ml of DMF were added dropwise a few drops of thymolphthalein reagent and a solution of 0.568 g of sodium methoxide dissolved in 100 ml of methanol, thereby obtaining the acid value by titration to a color change.

(Measurement of Static Contact Angle)

Pure water was dripped on the surface of a clear film of approximately 20 μm thickness obtained by drying the resin solution by hot air at 250° C. for four hours or the surface of the porous layer of the obtained separator. Measurement was made of the static contact angle of the surface with pure water 15 seconds after the dripping.

(Molecular Weight Distribution)

A sample of the resin solution was analyzed in terms of molecular weight distribution by using dimethylformamide as a developing solvent to set the sample concentration at 0.05% and attaching analyzing columns (TSKgel GMH_{XL}×2 and TSKgel G2000H_{XL}, all manufactured by Tosoh Corporation) to Shodex GPC SYSTEM-21. The molecular weight distribution was determined from the ratio of weight average molecular weight (Mw) to number average molecular weight (Mn).

(Air Permeability [sec/100 ml])

The air permeability was measured according to JIS (Japanese Industrial Standards) P-8117 using a Gurley type Densometer Model B manufactured by Tester Sangyo Co., Ltd. The measurement was conducted five times. The average of the measured values was employed as the air permeability [sec/100 ml].

(Thickness [μm])

The thickness was measured using a contact type film thickness meter (trade name “micro-mate M-30”, manufactured by Sony Corporation).

### Example A2

Polyamideimide resin was synthesized in the same manner as in Example A1 except that the amount of trimellitic anhydride was 0.97 mol and the amount of trimesic acid was 0.03 mol. The solvent-soluble polyamideimide resin thus obtained had a solid content concentration of 20% by weight and a logarithmic viscosity of 0.6 dl/g. The acid value of the resin was 19.6 KOHmg/g. The proportion of imide bonds to the total amount of imide bonds and amide bonds in the resin was 47%. The molecular weight distribution (Mw/Mn) of the resin was 2.7. The static contact angle of the resin with water was 81°. A separator was produced in the same manner as in Example A1.

### Example A3

Polyamideimide resin was synthesized in the same manner as in Example A1 except that the amount of trimellitic anhydride was 0.95 mol and the amount of trimesic acid was 0.05 mol. The solvent-soluble polyamideimide resin thus obtained had a solid content concentration of 20% by weight and a logarithmic viscosity of 0.6 dl/g. The acid value of the resin was 25.2 KOHmg/g. The proportion of imide bonds to the total amount of imide bonds and amide bonds in the resin was 45%. The molecular weight distribution (Mw/Mn) of the resin was 2.8. The static contact angle of the resin with water was 76°. A separator was produced in the same manner as in Example A1.

### Example A4

Polyamideimide resin was synthesized in the same manner as in Example A1 except that 0.99 mol of trimellitic anhydride, 0.01 mol of trimesic acid, 0.7 mol of o-tolidine diisocyanate and 0.3 mol of 2,6-tolylene diisocyanate were used as source materials. The solvent-soluble polyamideimide resin thus obtained had a solid content concentration of 20% by weight and a logarithmic viscosity of 1.4 dl/g. The acid value of the resin was 5.8 KOHmg/g. The proportion of imide bonds to the total amount of imide bonds and amide bonds in the resin was 48%. The molecular weight distribution (Mw/Mn) of the resin was 2.5. The static contact angle of the resin with water was 85°. A separator was produced in the same manner as in Example A1.

### Comparative Example W1

### Production of Separator

### Synthesis of Carboxyl Group-Containing Resin

In a four-necked flask provided with a condenser and a nitrogen gas inlet, 1.0 mol of trimellitic anhydride, 0.2 mol of 4,4′-diaminodiphenylmethane and 0.8 mol of 4,4′-diaminodiphenylmethane diisocyanate were mixed with N-methyl-2-pyrrolidone (NMP) to give a solid content concentration of 20% by weight, and 0.01 mol of diazabicycloundecene was added as a catalyst to the mixture. The mixture was stirred in the flask and allowed to react at 120° C. for four hours.

The solvent-soluble polyamideimide resin thus obtained had a solid content concentration of 20% by weight and a logarithmic viscosity of 0.5 dl/g. The acid value of the resin was 35.3 KOHmg/g. The proportion of imide bonds to the total amount of imide bonds and amide bonds in the resin was 33%. The molecular weight distribution (Mw/Mn) of the resin was 3.1. The static contact angle of the resin with water was 70°.

Preparation of Application Liquid and Production of Separator

Next, an application liquid was prepared in the same manner as in Example A1 except that the polyamideimide resin obtained as above was used. Then, a separator was produced using the application liquid in the same manner as in Example A1.

### Comparative Example W2

Polyamideimide resin was synthesized in the same manner as in Example A1 except that the amount of 4,4′-diaminodiphenylmethane diisocyanate was 0.97 mol. The solvent-soluble polyamideimide resin thus obtained had a solid content concentration of 20% by weight and a logarithmic viscosity of 0.4 dl/g. The acid value of the resin was 23.5 KOHmg/g. The molecular weight distribution (Mw/Mn) of the resin was 3.7. The static contact angle of the resin with water was 78°. A separator was produced using the resin in the same manner as in Example A1.

### Comparative Example W3

Polyamideimide resin was synthesized in the same manner as in Example A1 except that the amount of diazabicycloundecene was 0.02 mol and the reaction time was eight hours. The solvent-soluble polyamideimide resin thus obtained had a solid content concentration of 20% by weight and a logarithmic viscosity of 1.6 dl/g. The acid value of the resin was 4.8 KOHmg/g. The molecular weight distribution (Mw/Mn) of the resin was 3. The static contact angle of the resin with water was 94°. A separator was produced using the resin in the same manner as in Example A1.

[Evaluation of Resin Binder for Swellability and Solubility in Nonaqueous Electrolytic Solution]

To evaluate the resin binders prepared in Examples A1 to A4 and Comparative Examples W1 to W3 for swellability and solubility in nonaqueous electrolytic solution, each of the separators produced in Examples A1 to A4 and Comparative Examples W1 to W3 was immersed into a nonaqueous electrolytic solution, and observation was made of the state of inorganic fine particles in the porous layer of the separator. The electrolytic solution used was a nonaqueous electrolytic solution in which LiPF6 was dissolved in a mixed solvent of ethylene carbonate (EC) and diethyl carbonate (DEC) (volume ratio: 3:7) in a proportion of 1 mol of LiPF₆ per liter of the mixed solvent. TABLE 1 shows the states of the porous layers when each separator was immersed in the nonaqueous electrolytic solution. TABLE 1 also shows the logarithmic viscosities, acid values and static contact angles with water of the polyamideimide resins obtained in the above Examples and Comparative Examples.

TABLE 1

| | Logarithmic | Molecular Weight | | Static Contact | |
|---|---|---|---|---|---|
| | Viscosity | Distribution | Acid Value | Angle | |
| | [dl/g] | [Mw/Mn] | [KOHmg/g] | [°] | State of Porous Layer |
| Ex. A1 | 0.6 | 2.7 | 11.2 | 85 | No falling off of inorganic fine particles |
| Ex. A2 | 0.6 | 2.7 | 19.6 | 81 | No falling off of inorganic fine particles |
| Ex. A3 | 0.6 | 2.8 | 25.2 | 76 | No falling off of inorganic fine particles |
| Ex. A4 | 1.4 | 2.5 | 5.8 | 85 | No falling off of inorganic fine particles |
| Comp. Ex. W1 | 0.5 | 3.1 | 35.3 | 70 | Swelling in electrolyte and falling off of inorganic fine particles |
| Comp. Ex. W2 | 0.4 | 3.7 | 23.5 | 78 | Swelling in electrolyte and falling off of inorganic fine particles |
| Comp. Ex. W3 | 1.6 | 3.0 | 4.8 | 94 | No falling off of inorganic fine particles but low rate of |
| | | | | | electrolyte permeation |

As shown in TABLE 1, no falling off of inorganic fine particles was observed in the porous layers in Examples A1 to A4 using resin binders according to the present invention. It can be assumed that the reason for this is that the resin binders in the porous layers had an appropriate affinity to the nonaqueous electrolytic solution and did not have excessive swellability and solubility in the nonaqueous electrolytic solution. In contrast, in Comparative Example W1 in which the resin had an acid value of above 28.0 KOHmg/g, the resin in the porous layer swelled in the nonaqueous electrolytic solution and the inorganic fine particles fell off. In Comparative Example W3 in which the resin has an acid value of below 5.6 KOHmg/g, no falling off of inorganic fine particles was observed, but the rate of permeation of the nonaqueous electrolytic solution into the porous layer was low, resulting in poor nonaqueous electrolyte permeability into an electrode and poor electrolyte retentivity of the electrode.

In Comparative Example W2, the resin had an acid value within the acid value range according to the present invention but its logarithmic viscosity was below 0.5 dl/g. Thus, the porous layer exhibited swellability in the nonaqueous electrolytic solution, and falling off of inorganic fine particles was observed. Furthermore, in Comparative Example W3 in which the resin had an acid value of below 5.6 KOHmg/g, the logarithmic viscosity was higher than 1.5 dl/g.

As seen from the above, if the acid value of a resin is within the range of 5.6 to 28.0 KOHmg/g and the logarithmic viscosity thereof is within the range of 0.5 to 1.5 dl/g, there can be provided a resin binder not exhibiting swellability and solubility that would otherwise provide disadvantages, such as falling off of inorganic fine particles in the porous layer, and having an appropriate affinity to nonaqueous electrolyte.

[Evaluation of Application Liquids]

The application liquids prepared in Example A1 described above, Examples A5 and A6 described below and Comparative Examples W4 and W5 described below were evaluated in the following manners.

### Example A5

An application liquid A5 was prepared in the same manner as in Example A1 except that the polyamideimide resin and titanium oxide were mixed to give a ratio of 10 parts by weight of polyamideimide resin to 90 parts by weight of titanium oxide in the porous layer.

### Example A6

An application liquid A6 was prepared in the same manner as in Example A1 except that the polyamideimide resin and titanium oxide were mixed to give a ratio of 15 parts by weight of polyamideimide resin to 85 parts by weight of titanium oxide in the porous layer.

### Comparative Example W4

An application liquid W4 was prepared in the same manner as in Example A1 except that the polyamideimide resin and titanium oxide were mixed to give a ratio of 4 parts by weight of polyamideimide resin to 96 parts by weight of titanium oxide in the porous layer.

### Comparative Example W5

An application liquid W5 was prepared in the same manner as in Example A1 except that the polyamideimide resin and titanium oxide were mixed to give a ratio of 3 parts by weight of polyamideimide resin to 97 parts by weight of titanium oxide in the porous layer.

(Adherence after Film Formation)

Evaluation was made based on the following criteria for the adherence between the porous separator substrate and the porous layer when the porous layer was formed by applying the application liquid on the separator substrate.

Good: a state in which no delamination is observed in the porous layer after the film formation

Partly delaminated: a state in which delamination is observed even in part of the porous layer after the film formation

No adhesion: a state in which the porous layer does not adhere to the substrate after the film formation

(Delamination in Battery Production Process)

Example A1 and Comparative Example W1 were evaluated for delamination in the battery production process. A separator was interposed between positive and negative electrodes to be hereinafter described, and these components were helically winded up together and pressed down in a flattened form to produce an electrode assembly. Evaluation was made for the state between the separator substrate and the porous layer in the separator of the obtained assembly based on the following criteria:

No delamination: a state in which no delamination is observed in the porous layer in the battery production process

Partly delaminated: a state in which delamination is observed even in part of the porous layer in the battery production process

The evaluation results of the above examples obtained in the above manners are shown in TABLE 2.

TABLE 2

| | Resin Binder-to- | | Delamination |
|---|---|---|---|
| | Inorganic | Adherence | in Battery |
| | Fine Particle | After | Production |
| | Weight Ratio | Film Formation | Process |
| Ex. A1 | 5:95 | Good | No Delamination |
| Ex. A5 | 10:90 | Good | No Delamination |
| Ex. A6 | 15:85 | Good | No Delamination |
| Comp. Ex. W4 | 4:96 | Partly | Partly Delaminated |
| | | Delaminated | |
| Comp. Ex. W5 | 3:97 | No Adhesion | |

As shown in TABLE 2, the separators obtained in Examples A1, A5 and A6 were good in adherence after the film formation and anti-delamination in the battery production process. In contrast, in Comparative Example W4, partial delamination was observed between the separator substrate and the porous layer after the film formation and in the battery production process. In Comparative Example W5, the porous layer did not adhere to the separator substrate after the film formation, whereby the separator could not be formed.

As is obvious from the results shown in TABLE 2, it can be seen that the content of the resin binder in the porous layer in the present invention is preferably 5% by weight or more.

### Production of Battery and Continuous Charge Test

### Example B1

### Production of Positive Electrode

Lithium cobaltate serving as a positive-electrode active material, graphite serving as a conductive carbon material (trade name “SP300”, manufactured by Nippon Graphite Industries, Ltd.) and acetylene black were mixed in a mass ratio of 92:3:2. The mixture was put into a mixer (a mechanofusion system “AM-15F” made by Hosokawa Micron Corporation), and mixed while being subjected to compression, impact and shearing action by operating the mixer at 1500 rpm for 10 minutes, thereby obtaining a mixed positive-electrode active material.

Next, the mixed positive-electrode active material and a fluorine-containing resin binder (poly(vinylidene fluoride): PVDF) were incorporated into a solvent of N-methyl-2-pyrrolidone (NMP) to give a mixed positive-electrode active material to binder mass ratio of 97:3, and mixed, thereby preparing a positive electrode mixture slurry.

The obtained positive electrode mixture slurry was applied on both surfaces of a piece of aluminum foil, dried and then rolled, thereby producing a positive electrode.

[Production of Negative Electrode]

Graphite serving as a negative-electrode active material, CMC (carboxymethylcellulose sodium) and SBR (styrene butadiene rubber) were mixed in amass ratio of 98:1:1 in an aqueous solution. The mixture was applied on both surfaces of a piece of copper foil, dried and rolled, thereby producing a negative electrode.

[Preparation of Nonaqueous Electrolytic Solution]

Ethylene carbonate (EC) and diethyl carbonate (DEC) were mixed to give an EC to DEC volume ratio of 3:7. In the mixed solvent was dissolved LiPF₆ to give a concentration of 1 mol per liter of the solvent, thereby preparing a nonaqueous electrolytic solution.

[Production of Nonaqueous Electrolyte Secondary Battery]

A lithium ion secondary battery was produced using the separator produced in Example A1 and the above-described positive electrode, negative electrode and nonaqueous electrolytic solution. Lead terminals were attached to the positive and negative electrodes, and the separator was interposed between the electrodes. Then, these components were helically winded up together and pressed down in a flattened form to produce an electrode assembly. The electrode assembly was placed into a battery outer package made of an aluminum laminate. Into the battery outer package was then poured the nonaqueous electrolytic solution, followed by sealing of the outer package, thereby producing a lithium ion secondary battery. Note that the design capacity of the battery is 780 mAh.

[Continuous Charge Test]

### Charge-Discharge Test

The battery was charged at a constant current of 1 It (750 mAh) to a battery voltage of 4.30 V (4.40 V (vs. Li/Li⁺)) and then charged at a constant battery voltage of 4.30 V (4.40 V (vs. Li/Li⁺)) to reach 0.05 It (37.5 mAh). After a 10-minute pause, the battery was discharged at a constant current of 1 It (750 mAh) to a battery voltage of 2.75 V (2.85 V (vs. Li/Li⁺)) and then measured in terms of discharge capacity.

### Continuous Charge Test

In a thermostat bath at 60° C., the battery was charged at a constant current of 1 It (750 mAh) to a battery voltage of 4.30 V (4.40 V (vs. Li/Li⁺)) and then charged at a constant battery voltage of 4.30 V (4.40 V (vs. Li/Li⁺)) over five days (120 hours) without being cut off depending upon any current value. After cooled down to room temperature, the battery was discharged at a constant current of 1 It (750 mAh) to a battery voltage of 2.75 V (2.85 V (vs. Li/Li⁺)) and then measured in terms of discharge capacity.

The discharge capacity retention was calculated from the ratio of discharge capacity after the continuous charge test to the discharge capacity before the continuous charge test using the following equation:

Discharge Capacity Retention(%)=[(Discharge Capacity

After Continuous Charge(mAh))/(Discharge Capacity Before

Continuous Charge(mAh))]×100

### Example B2

A continuous charge test was conducted in the same manner as in Example B1 except that the end-of-charge voltage was set at a battery voltage of 4.32 V (4.42 V (vs. Li/Li⁺)).

### Example B3

A continuous charge test was conducted in the same manner as in Example B1 except that the end-of-charge voltage was set at a battery voltage of 4.34 V (4.44 V (vs. Li/Li⁺)).

### Example B4

A continuous charge test was conducted in the same manner as in Example B1 except that the end-of-charge voltage was set at a battery voltage of 4.36 V (4.46 V (vs. Li/Li⁺)).

### Example B5

A continuous charge test was conducted in the same manner as in Example B1 except that the end-of-charge voltage was set at a battery voltage of 4.38 V (4.48 V (vs. Li/Li⁺)).

### Comparative Example Z1

### Synthesis of Resin

In a four-necked flask provided with a condenser and a nitrogen gas inlet, 0.75 mol of trimellitic anhydride, 0.25 mol of isophthalic acid and 1.0 mol of 4,4′-diaminodiphenylmethane diisocyanate were mixed with NMP to give a solid content concentration of 20% by weight, and 0.01 mol of diazabicycloundecene was added as a catalyst to the mixture. The mixture was stirred and allowed to react at 120° C. for four hours.

The solvent-soluble polyamideimide resin thus obtained had a solid content concentration of 20% by weight and a logarithmic viscosity of 0.8 g/dl. The acid value of the resin was 3.9 KOHmg/g. The proportion of imide bonds to the total amount of imide bonds and amide bonds in the resin was 37%. The molecular weight distribution of the resin was 2.4. The static contact angle of the resin with water was 93°.

A separator was produced in the same manner as in Example A1 except that this carboxyl group-containing resin was used as a resin binder. Then, using the separator, a battery was produced in the same manner as in Example B1. The battery was subjected to a continuous charge test in the same manner as in Example B1.

### Comparative Example Z2

A continuous charge test was conducted in the same manner as in Comparative Example Z1 except that the end-of-charge voltage was set at a battery voltage of 4.32 V (4.42 V (vs. Li/Li⁺)).

### Comparative Example Z3

A continuous charge test was conducted in the same manner as in Comparative Example Z1 except that the end-of-charge voltage was set at a battery voltage of 4.34 V (4.44 V (vs. Li/Li⁺)).

### Comparative Example Z4

A continuous charge test was conducted in the same manner as in Comparative Example Z1 except that the end-of-charge voltage was set at a battery voltage of 4.36 V (4.46 V (vs. Li/Li⁺)).

### Comparative Example Z5

A continuous charge test was conducted in the same manner as in Comparative Example Z1 except that the end-of-charge voltage was set at a battery voltage of 4.38 V (4.48 V (vs. Li/Li⁺)).

The discharge capacity retentions of Examples B1 to B5 and Comparative Examples Z1 to Z5 are shown in TABLE 3 and FIG. 2.

TABLE 3

| | Acid Value | | | Discharge |
|---|---|---|---|---|
| | of | Imide Bond | End-of-Charge | Capacity |
| | Resin Binder | Proportion | Voltage | Retention |
| | (KOHmg/g) | (%) | (V) | (%) |
| Ex. B1 | 11.2 | 48 | 4.30 | 66 |
| Ex. B2 | 11.2 | 48 | 4.32 | 61 |
| Ex. B3 | 11.2 | 48 | 4.34 | 60 |
| Ex. B4 | 11.2 | 48 | 4.36 | 47 |
| Ex. B5 | 11.2 | 48 | 4.38 | 48 |
| Comp. Ex. Z1 | 3.9 | 37 | 4.30 | 64 |
| Comp. Ex. Z2 | 3.9 | 37 | 4.32 | 56 |
| Comp. Ex. Z3 | 3.9 | 37 | 4.34 | 0 |
| Comp. Ex. Z4 | 3.9 | 37 | 4.36 | 0 |
| Comp. Ex. Z5 | 3.9 | 37 | 4.38 | 0 |

As shown in TABLE 3 and FIG. 2, it can be seen that, in Comparative Examples Z1 to Z5 in which the acid value of the resin was below 5.6 KOHmg/g, the discharge capacity retention decreased when the end-of-charge voltage was above 4.30V in battery voltage. In contrast, it can be seen that, in Examples B1 to B5 in which the acid value of the resin was within the range of 5.6 to 28.0 KOHmg/g, the decrease in discharge capacity retention could be reduced even when the end-of-charge voltage was above 4.30 V in battery voltage. It can be assumed that the reason for this is that since the acid value of the resin binder in the porous layer was within the range of 5.6 to 28.0 KOHmg/g, the electron density of the resin main chain could be reduced to reduce the electron abstraction reaction due to oxidation and thereby reduce oxidative decomposition.

Therefore, according to the present invention, the nonaqueous electrolyte battery can obtain a good high-temperature charge characteristic.

1. A separator used for a nonaqueous electrolyte battery, wherein
the separator is formed by disposing a porous layer made of inorganic fine particles and a resin binder on a porous separator substrate,
the resin binder is made of at least one resin selected from the group consisting of polyimide resins and polyamideimide resins, the resin having an acid value of 5.6 to 28.0 KOHmg/g and a logarithmic viscosity of 0.5 to 1.5 dl/g, and
the content of the resin binder in the porous layer is 5% by weight or more.

2. The separator for the nonaqueous electrolyte battery according to claim 1, wherein the proportion of imide bonds to the total amount of imide bonds and amide bonds in the resin binder is 40% to 100%.

3. The separator for the nonaqueous electrolyte battery according to claim 1, wherein the molecular weight distribution (Mw/Mn) of the resin binder is within the range of 2 to 4.

4. The separator for the nonaqueous electrolyte battery according to claim 1, wherein the static contact angle of the resin binder with water is not more than 90°.

5. The separator for the nonaqueous electrolyte battery according to claim 1, wherein the inorganic fine particles are made of at least one selected from the group consisting of alumina and titania.

6. The separator for the nonaqueous electrolyte battery according to claim 1, wherein the content of the resin binder in the porous layer is 5% to 15% by weight.

7. A nonaqueous electrolyte battery comprising: a positive electrode; a negative electrode; the separator according to claim 1 disposed between the positive and negative electrodes; and a nonaqueous electrolyte.

8. The nonaqueous electrolyte battery according to claim 7, wherein the porous layer is disposed on the positive electrode side of the separator.

9. The nonaqueous electrolyte battery according to claim 7, wherein the positive electrode is capable of being charged to above 4.40 V (vs. Li/Li⁺).
